(19) United States
(12) Patent Application Publication
(10) Pub. No.: US 2023/0289779 A1
(43) Pub. Date: Sep. 14, 2023

(54) SYSTEM AND METHOD FOR AUTOMATICALLY VALIDATING USERS TO ACCESS BLOCKCHAIN BASED APPLICATIONS

(71) Applicant: Pocketful of Quarters, Inc., Riverside, CT (US)

(72) Inventors: George Michael WEIKSNER, Riverside, CT (US); Mark ROSZAK, Chicago, IL (US)

(73) Assignee: Pocketful of Quarters, Inc., Riverside, CT (US)

(21) Appl. No.: 18/180,805

(22) Filed: Mar. 8, 2023

Related U.S. Application Data
(60) Provisional application No. 63/317,663, filed on Mar. 8, 2022.

(51) Int. Cl. G06Q 20/36; G06Q 20/38; G06Q 20/40; G06Q 20/32; H04L 9/40; H04W 12/63

(52) U.S. Cl. CPC G06Q 20/3674; G06Q 20/3678; G06Q 20/389; G06Q 20/4015; G06Q 20/3255; H04L 63/101; H04W 12/63

(57) ABSTRACT

A system and method are provided for automatically validating users through a country, location or residence specific manner, for example to permit access to a blockchain enabled application. Optionally, such validation comprises transmission of a code to a valid communication device, capable of receiving an SMS or other message type, that validates the location and/or citizenship of the user. Optionally, additionally or alternatively, such validation comprises the application of a national citizenship and/or residency based digital schema, such as the DigiD digital identification schema of the Netherlands. The user may be validated as being a resident or citizen of a country, and/or otherwise having a valid attachment to a particular country, location or residence. Alternatively, the user may be validated as not being a resident or citizen of a country, and/or otherwise as not having a valid attachment to a particular country, location or residence.

### CROSS REFERENCE TO RELATED APPLICATIONS

The present application claims priority to U.S. Provisional Patent Application No. 63/317,663, filed Mar. 8, 2022, entitled “SYSTEM AND METHOD FOR AUTOMATICALLY VALIDATING USERS,” the disclosure thereof incorporated by reference herein in its entirety.

The present application is related to U.S. Pat. No. 11,189,131, issued Nov. 30, 2021, entitled “SYSTEM AND METHOD FOR BLOCKCHAIN TOKENS FOR GAMING,” the disclosure thereof incorporated by reference herein in its entirety.

### DESCRIPTION OF RELATED ART

The present invention relates to a system and method for automatically validating users, and in particular, for such a system and method in which automatic validation is performed through blockchain.

### BACKGROUND

Blockchain technology may be applied in a variety of situations, for example to ensure transparency and traceability of transactions. Many cryptocurrencies such as Bitcoin are actually pseudonymous rather than anonymous, such that transactions are trackable according to a user identifier, such as a wallet identifier for example.

However, the rules and regulations surrounding blockchain are still unclear. In some circumstances, the application of technology to a particular blockchain may be blocked under a national law. For example, some types of fungible tokens, such as those usable as a cryptocurrency, may not be legally sold to citizens and/or residents of some countries. These rules are still evolving and changing, such that determining which rules are applicable to which blockchain applications can be quite difficult.

### SUMMARY

The background art does not teach or suggest a system or method for automatically validating users through application of blockchain technology, in a manner which is flexible to accommodate changing rules around blockchain.

The present invention overcomes these drawbacks of the background art by providing a system and method for automatically validating users through a country, location or residence specific manner. Optionally, such validation comprises transmission of a code to a valid communication device, capable of receiving an SMS or other message type, that validates the location and/or citizenship of the user. Optionally, additionally or alternatively, such validation comprises the application of a national citizenship and/or residency based digital schema, such as the DigiD digital identification schema of the Netherlands. Some embodiments may be employed to implement portions of the Open Authorization (OAuth) standard.

The user may be validated as being a resident or citizen of a country, and/or otherwise having a valid attachment to a particular country, location or residence. Alternatively, the user may be validated as not being a resident or citizen of a country, and/or otherwise as not having a valid attachment to a particular country, location or residence. Such validation is collectively termed herein “location based validation”. Once the user has successfully performed such location based validation, information regarding such successful validation may be stored on a blockchain, for example as a record and/or to permit future access to such validation. Optionally such validation may be required periodically.

Once such validation has been successfully performed, the associated user may then receive access to at least one blockchain enabled application, including without limitation being able to purchase and/or otherwise receive one or more tokens; being able to purchase and/or otherwise receive; and being able to purchase and/or otherwise receive access to a particular blockchain and/or technology enabled by same.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions. The processor may be configured to execute a predefined set of operations in response to receiving a corresponding instruction selected from a predefined native instruction set of codes.

Software (e.g., an application, computer instructions) which may be configured to perform (or cause to be performed) certain functionality may also be referred to as a “module” for performing that functionality, and also may be referred to a “processor” for performing such functionality. Thus, processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions—which can be a set of instructions, an application, software—which are operable on a computational device (e.g., a processor) to cause the computational device to conduct and/or achieve one or more specific functionality.

Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, an iPad or other tablet, a game console, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIGS. 1A and 1B show non-limiting exemplary systems for performing location based validation, according to some embodiments of the disclosed technology;

FIGS. 2A and 2B show non-limiting exemplary versions of systems for enabling a user with successful location based validation to access a blockchain enabled application, according to some embodiments of the disclosed technology;

FIG. 3 shows a non-limiting exemplary validation engine, according to some embodiments of the disclosed technology; and

FIG. 4 shows a non-limiting exemplary method for validation, according to some embodiments of the disclosed technology.

The figures are not exhaustive and do not limit the present disclosure to the precise form disclosed.

### DETAILED DESCRIPTION

A blockchain is a distributed database that maintains a list of data records, the security of which is enhanced by the distributed nature of the blockchain. A blockchain typically includes several nodes, which may be one or more systems, machines, computers, databases, data stores or the like operably connected with one another. In some cases, each of the nodes or multiple nodes are maintained by different entities. A blockchain typically works without a central repository or single administrator. One well-known application of a blockchain is the public ledger of transactions for cryptocurrencies such as used in bitcoin. The recorded data records on the blockchain are enforced cryptographically and stored on the nodes of the blockchain.

A blockchain provides numerous advantages over traditional databases. A large number of nodes of a blockchain may reach a consensus regarding the validity of a transaction contained on the transaction ledger. Similarly, when multiple versions of a document or transaction exist on the ledger, multiple nodes can converge on the most up-to-date version of the transaction. For example, in the case of a virtual currency transaction, any node within the blockchain that creates a transaction can determine within a level of certainty whether the transaction can take place and become final by confirming that no conflicting transactions (i.e., the same currency unit has not already been spent) confirmed by the blockchain elsewhere.

The blockchain typically has two primary types of records. The first type is the transaction type, which consists of the actual data stored in the blockchain. The second type is the block type, which are records that confirm when and in what sequence certain transactions became recorded as part of the blockchain. Transactions are created by participants using the blockchain in its normal course of business, for example, when someone sends cryptocurrency to another person), and blocks are created by users known as “miners” who use specialized software/equipment to create blocks. Users of the blockchain create transactions that are passed around to various nodes of the blockchain. A “valid” transaction is one that can be validated based on a set of rules that are defined by the particular system implementing the blockchain.

In some blockchain systems, miners are incentivized to create blocks by a rewards structure that offers a pre-defined per-block reward and/or fees offered within the transactions validated themselves. Thus, when a miner successfully validates a transaction on the blockchain, the miner may receive rewards and/or fees as an incentive to continue creating new blocks.

Preferably, the blockchain(s) that is/are implemented are capable of running code, to facilitate the use of smart contracts. Smart contracts are computer processes that facilitate, verify, and/or enforce negotiation and/or performance of a contract between parties. One fundamental purpose of smart contracts is to integrate the practice of contract law and related business practices with electronic commerce protocols between people on the Internet. Smart contracts may leverage a user interface that provides one or more parties or administrators access, which may be restricted at varying levels for different people, to the terms and logic of the contract.

Smart contracts typically include logic that emulates contractual clauses that are partially or fully self-executing and/or self-enforcing. Examples of smart contracts are digital rights management (DRM) used for protecting copyrighted works, financial cryptography schemes for financial contracts, admission control schemes, token bucket algorithms, other quality of service mechanisms for assistance in facilitating network service level agreements, person-to-person network mechanisms for ensuring fair contributions of users, and others.

Smart contracts may also be described as pre-written logic (computer code), stored and replicated on a distributed storage platform (e.g. a blockchain), executed/run by a network of computers (which may be the same ones running the blockchain), which can result in ledger updates (cryptocurrency payments, etc.).

Smart contract infrastructure can be implemented by replicated asset registries and contract execution using cryptographic hash chains and Byzantine fault tolerant replication. For example, each node in a peer-to-peer network or blockchain distributed network may act as a title registry and escrow, thereby executing changes of ownership and implementing sets of predetermined rules that govern transactions on the network. Each node may also check the work of other nodes and in some cases, as noted above, function as miners or validators.

Not all blockchains can execute all types of smart contracts. For example, Bitcoin cannot currently execute smart contracts. Sidechains, i.e. blockchains connected to Bitcoin's main blockchain could enable smart contract functionality: by having different blockchains running in parallel to Bitcoin, with an ability to jump value between Bitcoin's main chain and the side chains, side chains could be used to execute logic. Smart contracts that are supported by sidechains are contemplated as being included within the blockchain enabled smart contracts that are described below.

For all of these examples, security for the blockchain may optionally and preferably be provided through cryptography, such as public/private key, hash function or digital signature, as is known in the art.

As described herein, the term “token” may also include tokens, coins or NFTs (non-fungible tokens), or any digital asset for which at least title, and preferably provenance and chain of title, may be written to a blockchain.

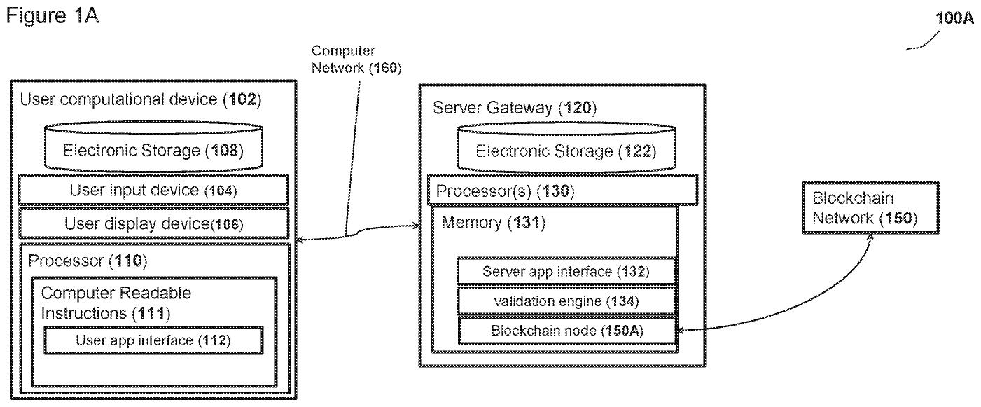

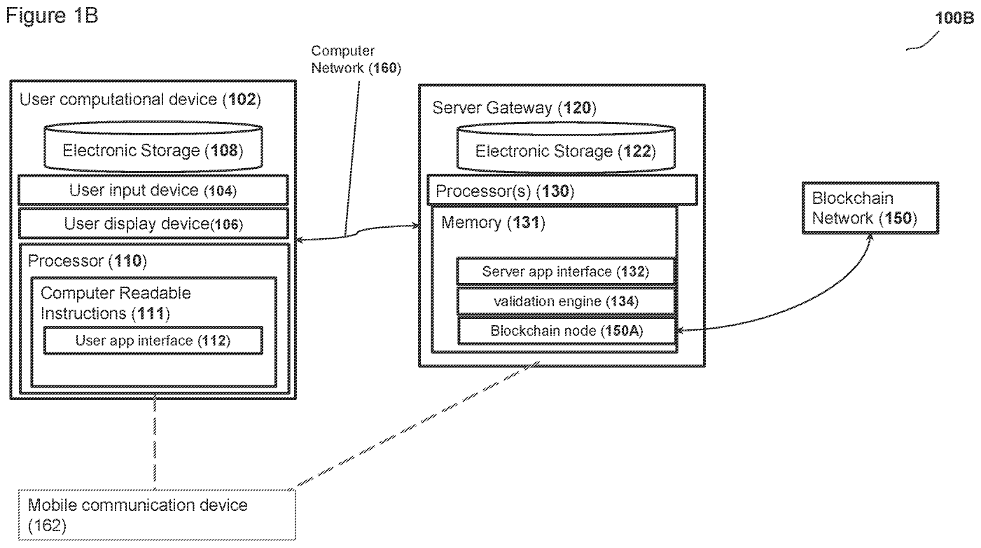

FIGS. 1A and 1B show non-limiting exemplary systems for performing location based validation. As shown with regard to FIG. 1A, there may be provided an exemplary non-limiting system for performing location based validation of a user. As shown with regard to system 100A, there may be provided a user computational device 102, which communicates through a computer network 160 with the server gateway 120. User computational device 102 features a user app interface 112, for being operated by the user as part of the location based validation process. User computational device 102 further comprises communication technology to support location based validation.

User computational device 102 may be in communication with a server gateway 120 through a computer network 160, which preferably supports the communication technology for location based validation. For example and without limitation, if user computational device 102 may be a smart phone or other mobile communication device, then user computational device 102 may transmit location based information to server gateway 120.

Alternatively or additionally, if user computational device 102 may be able to receive a communication that may be location based, such as for example an SMS (short message service) message, then server gateway 120 may transmit such a communication through computer network 160. For transmission of SMS messages, computer network 160 preferably comprises a cellular communication network and user computational device 102 preferably may be a smart phone or other mobile communication device. User computational device 102 in such a situation preferably features an associated telephone number. User computational device 102 may then be used to transmit a code received through such a location based message back to server gateway 120.

Also alternatively or additionally, if user computational device 102 is able to support user verification through a national residency and/or citizenship based digital identification service, then such verification may be performed and the results submitted to server gateway 120. Other configurations of user computational device 102 and server gateway 120 may be used to verify the physical location of the user associated with user computational device 102, and are contemplated herein.

User computational device 102 preferably also includes the user input device 104, and user display device 106. The user input device 104 may optionally be any type of suitable input device including but not limited to a keyboard, microphone, mouse, or other pointing device and the like. Preferably user input device 104 includes a list, a microphone and a keyboard, mouse, or keyboard mouse combination. User display device 106 may be able to display information to the user for example from user app interface 112.

User computational device 102 also comprises a processor 110 and a memory containing computer readable instructions 111. Functions of processor 110 preferably relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, the memory may be configured for storing a defined native instruction set of codes. Processor 110 may be configured to perform a defined set of basic operations in response to receiving a corresponding basic instruction selected from the defined native instruction set of codes stored in the memory. For example and without limitation, the memory may store a first set of machine codes selected from the native instruction set for receiving information from the user through user app interface 112, such as a code that determines the location of the user for location based validation, and a second set of machine codes selected from the native instruction set for transmitting such information to server gateway 120 for location based validation.

Server gateway 120 features a validation engine 134 for performing location based validation. Preferably, validation engine 134 then writes such validation information to or reads such validation information from blockchain node 150A. Blockchain node 150A may be for example part of a blockchain network 150. Once the user associated with user computational device 102 has successfully performed location based validation, server gateway 120 may provide access to a blockchain enabled technology. Alternatively or additionally, such access may be provided through a different server (not shown), which contacts server gateway 120 to determine the location based validation status of the user associated with user computational device 102.

Server gateway 120 preferably comprises a processor 130 and a memory with machine readable instructions, with related or at least similar functions to the processor and memory described above, including without limitation functions of server gateway 120 as described herein. For example and without limitation, memory 131 may store a first set of machine codes selected from the native instruction set for initiating location based validation with user computational device 102, and a second set of machine codes selected from the native instruction set for receiving validation information back from user computational device 102. Optionally memory 131 may store a third set of machine codes selected from the native instruction set for recording such validation information on blockchain network 150. Also optionally memory 131 may store a fourth set of machine codes selected from the native instruction set for permitting access to a blockchain enabled application, whether on blockchain network 150 or another blockchain (not shown), for user computational device 102 or another associated user computational device (not shown).

FIG. 1B shows a non-limiting exemplary system, which now also features a separate mobile communication device which may be associated with a user accessing the user computational device. Components with the same reference number as for FIG. 1A have the same or similar function. As shown in the system 100B, again user computational device 102 is featured, but user computational device 102 may be now optionally also communicating with a mobile communication device 162. Mobile communication device 162 may be in communication with server gateway 120. For example, if the user requests location based validation through user computational device 102, the user may be asked to provide a mobile telephone number through user app interface 112. Server gateway 120 may then transmit an SMS message to mobile communication device 162. The user may manually transfer a code from the SMS message to user app interface 112 and hence to server gateway 120. Alternatively or additionally, mobile communication device 162 may communicate directly with user computational device 102, which may then transfer the necessary information to server gateway 120. In either case, location based validation may be performed through such communication, for example for the reasons given above.

For either of the systems of FIG. 1A or 1B, optionally user computational device 102 and/or mobile communication device 162 may be used for trading cryptocurrency through SMS messages. Optionally, user computational device 102 and/or mobile communication device 162 may be used to send/receive notifications, including setting up smart contracts, participating in governance functions for a DAO (Decentralized Autonomous Organization), notify about an airdrop of a new cryptocurrency or receipt of an NFT (Non-Fungible Token), for example according to SMS messages.

Optionally, user computational device 102 and/or mobile communication device 162 may be used to send/receive SMS communications related to the actions of cryptocurrencies issuers, such as communications related to governance actions.

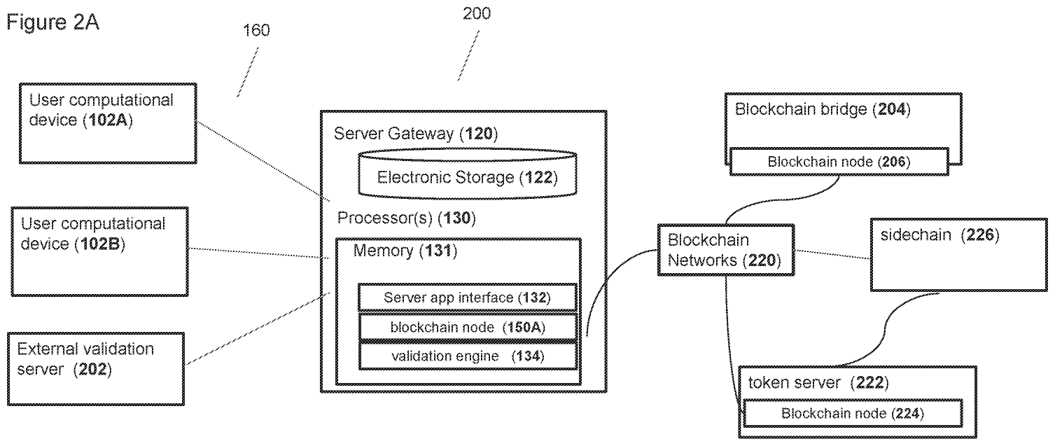

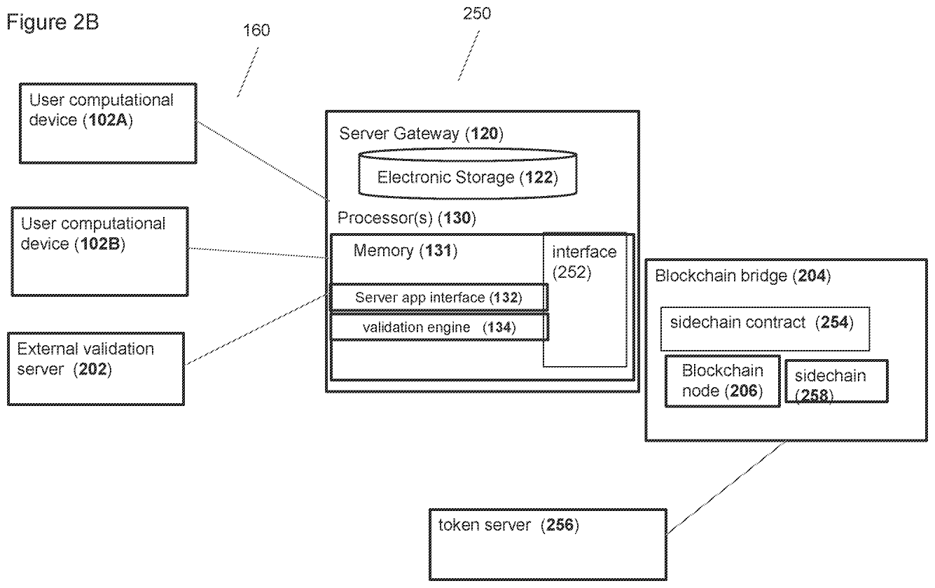

FIGS. 2A and 2B show non-limiting exemplary versions of systems for enabling a user with successful location based validation to access a blockchain enabled application. FIG. 2A shows a non-limiting exemplary system 200, featuring a plurality of user computational devices 102A and 102B, which may be used to access the blockchain enabled application. Again, components with the same reference numbers have the same or similar function. However, in this non-limiting example, validation may be performed through an external validation server 202, optionally alone or in combination with validation engine 134. For example, a user may request location based validation through user computational device 102A or 102B, to be able to obtain access to a particular blockchain enabled application. Such a blockchain enabled application may require validation through external validation server 202, which may for example have the policy, rules and/or requirements which are to be fulfilled before access is granted. Actual location based validation may be performed through the previously described process, after which validation engine 134 sends a notification of successful location based validation to external validation server 202. If the user had already performed location based validation through validation engine 134, such information may be read from blockchain network 150 and then transmitted to external validation server 202.

In this non-limiting example, a blockchain network 220 may act, for example, as a bridge or may be connected to additional blockchain networks through a blockchain bridge 204. For example, the user may wish to access a blockchain enabled application through blockchain bridge 204, blockchain network 150, a sidechain 226 and/or a token server 222. Token server 222 may provide cryptocurrency or other tokens, through a blockchain 224.

Also optionally, validation engine 134 may also write to a sidechain 226, for example through a blockchain network 220, which may for example, operate a smart contract, which is not shown. Token server 222 may be able to write to, or read from, sidechain 226 directly, or may be able to interact directly with validation engine 134. Also optionally, blockchain node 150A may be not present at server gateway 120 and instead, everything may be handled through these external interfaces which support blockchain interactions such as reading from the blockchain or writing to the blockchain.

FIG. 2B shows a non-limiting exemplary system 250. Again, components with the same reference numbers have the same or similar function. In this non-limiting example, the sidechain and blockchain interactions have been changed. As previously described as an optional implementation, server gateway 120 no longer has an associated blockchain node, and so can no longer read from or write to a blockchain node directly. Instead through interface 252, server gateway 120 interacts indirectly with the blockchain bridge 204. Blockchain bridge 204 may, for example, enable the user to interact with a sidechain support contract 254, which enables sidechain management. Sidechain support contract 254 enables interactions and transactions to be read from or written to sidechain 258, for example with regard to storage of validated location based information about a particular user. Again, sidechain support contract 254 may also write such interactions to blockchain node 206, for example to permit final storage of the location based validation information, to take place on the blockchain node 206 directly, as opposed to the sidechain 258. Blockchain bridge 204 may interact with the sidechain 258, but may do so through sidechain support contract 254. Through sidechain support contract 254, for example according to instructions sent to server gateway 120 from a respective user computational device 102A or 102B, a user can request location based validation and/or the ability to access a blockchain enabled application upon successful validation. A non-limiting example of such an application is obtaining tokens from token server 256. Optionally, users can interact with the sidechain directly (or with the blockchain).

Sidechain support contract 254 may be implemented in a plurality of different ways, including without limitation as a plasma contract (sometimes referred to as a “plasma bridge”) and/or as a PoS (Proof of Stake) bridge. A bridge comprises one or more smart contracts that are able to move assets from the root chain to the child (or side) chain, and then back. Both the PoS Bridge and the plasma bridge implementations are described in this reference on the Matic Network, provided as a non-limiting example only: https://docs.matic.network/docs/develop/ethereum-matic/pos/getting-started/.

In this non-limiting example, for example, user computational device 102A or 102B may be caused by the user to request location based validation, or use of a previously validated location, either with external validation server 202, which relies on server gateway 120, or token server 256, which interacts directly with blockchain bridge 204 and hence to server gateway 120.

In this non-limiting example, either external validation server 202 or token server 256 could then communicate with blockchain bridge 204, either directly or through server gateway 120, to request user validation. Optionally such information may be moved to sidechain 258 if repeated such requests are to be made, for example with a plurality of different token servers 256.

With regard to the systems shown in FIGS. 2A and 2B, optionally certain functions and/or transaction types may be automatically whitelisted or otherwise permitted. Smart contracts are, optionally and preferably, automatically whitelisted to avoid causing systemic blockages or stoppages. For example, automatically whitelisting smart contracts avoids a situation in which tokens or other instruments are able to be moved within a smart contract, but then cannot leave the smart contract, even if the original owner wishes to withdraw them because the transaction cannot be performed through the smart contract. As another example, transfers to/from a DAO may be automatically whitelisted. Other such functions and/or transaction types may also be automatically whitelisted.

Optionally, users who are permitted/whitelisted under another system may also be added to the whitelist for the system as described herein. Optionally, issuers and/or distributors of cryptocurrencies are permitted to access a list of cryptocurrency wallet addresses that have received previous distributions, for example to issue and/or distribute more and/or different cryptocurrencies. Also optionally, the system as described with regard to FIGS. 2A and 2B supports compliant secondary market trading that occurs via decentralized exchanges.

Each permission and/or whitelist as described herein may be managed centrally but may be preferably managed in a decentralized fashion, for example through a DAO or other decentralized administration structure.

Also optionally, a blacklist or reverse whitelist may be used. For example, a telephone number may be verified by SMS, after which server gateway compares the telephone number to a blacklist of entities, such that if the telephone number is on the blacklist of entities, the transaction is blocked. This comparison may be used for example for an OFAC Sanctions Check or other regulatory compliance check.

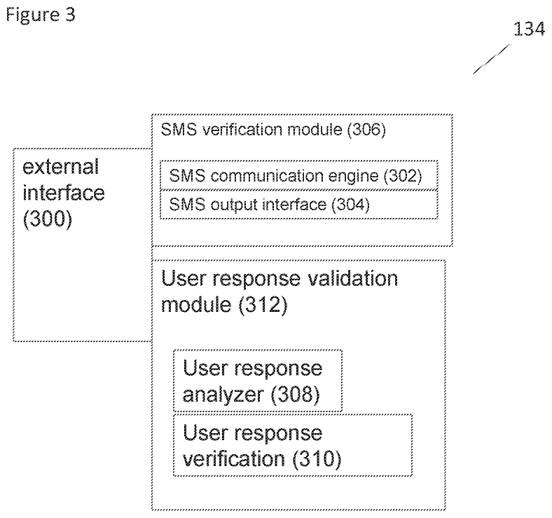

FIG. 3 shows a non-limiting exemplary validation engine 134, which was shown in the previous figures. In this non-limiting example, validation engine 134 features an external interface 300, which may be connected to an SMS verification module 306, as a non-limiting example of a type of location based validation. SMS verification module 306 preferably comprises an SMS communication engine 302, for transmitting and optionally receiving SMS messages to and from a user mobile communication device. Such messages may be sent through an SMS output interface 304. Information regarding the number to which the message was sent may be provided to SMS verification module 306 from external interface 300.

External interface 300 may also provide such information to a user response validation module 312. For example, the user may transmit a code in an SMS message, sent for the purpose of verifying the user's telephone number (and hence location information), back to validation engine 134. This code may then be received by user response validation module 312. A user response analyzer 308 may determine whether the code is correct. If so, this information is preferably passed to a user response verification 310. User response verification 310 preferably determines any available information about the location of the user mobile communication device. Once the correct code is received, then the user may be verified for that location by user response verification 310. This verification information may be then output by validation engine 134.

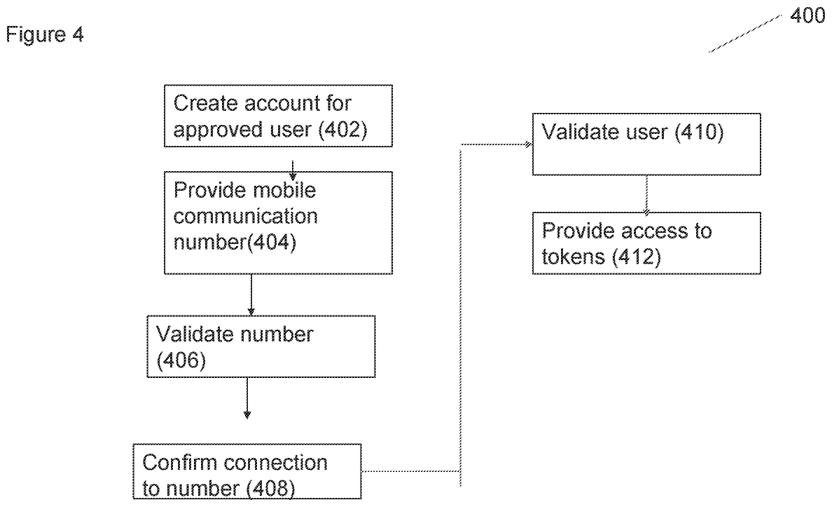

FIG. 4 shows a non-limiting exemplary method for providing access to a blockchain enabled application according to location based validation. Of course, other methods are also possible. This is only a non-limiting example. As shown in a method 400, an account may be created for an approved user at 402. This step may be used for example, to prevent money laundering. The user may be required to show some sort of user ID, as proof of age to avoid children signing up for the service or for using the service. The user ID may also be used to provide some sort of proof of location of the user so that the user's ID matches the location where the user lives or is currently present, again to prevent fraud. Other qualifications may be presented at this stage, so that the user may be determined to be qualified for the blockchain enabled application.

Next, at 404, a mobile communication number or other identifier may be provided for the location based validation process to be performed. As a non-limiting example, if a mobile communication number is provided, then an SMS message may be sent for validation. At 406, the number itself may be validated, for example to confirm that it is an actual mobile communication number (as opposed to a computer network phone number and/or landline number). The country or other location associated with this number may be preferably also validated.

At 408, the user's connection to the number may be confirmed, for example by sending an SMS message to that number or through some other type of verification and verifying a suitable response is received. At 410, if the number is associated with a correct location and the user's connection has been validated, then the user may be validated. At 412, if the user is validated, the user may receive access to a blockchain enabled application, such as receiving access to tokens as a non-limiting example.

Some embodiments may be employed to implement portions of the Open Authorization (OAuth) standard. For example, these embodiments may be used to provide access to blockchain based games. In such embodiments, after access to a game is granted to a user, the game may interact with the user, including collecting user data, user wallet information, user transaction history, past and current events, and a list of authorized games for the user. The system may enable a user to see what tokens the user has, to let users authorize games, and to transfer tokens to and from other logged in and authorized users. After a user logs in, the user can purchase items in the games with the tokens, receive tokens via gameplay, and transfer tokens between games. These token transfers may occur seamlessly, that is, without additional user interaction.

The system server may create private keys, and may store private keys encrypted in a database. The system server may handle Oauth authentication. The system server may provide API access to user wallets, including signing transactions on the system server to be submitted to the blockchain, for example using web3js. The access control provided by the system server may enable game companies to transfer tokens with and between logged in and authorized users.

In some embodiments, the token may be implemented as a smart contract that maintains a list of approved accounts (for developers). Token transfers may be allowed only between approved accounts. Any attempted transfers with an unapproved account may be rejected by the smart contract. The system may allow all accounts to mint new tokens with cryptocurrencies, including stablecoins. The system may limit the exchange of cryptocurrencies and stablecoins to approved accounts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for automatically validating users to access blockchain based applications, comprising:
one or more hardware processors; and
a non-transitory machine-readable storage medium encoded with instructions executable by the one or more hardware processors to perform operations comprising:
receiving, from a mobile telephone device, an electronic request for access to a blockchain based application;
obtaining a mobile telephone number of the mobile telephone device;
determining a geographical region associated with the mobile telephone number;
determining whether the geographical region allows access to the blockchain based application;
determining whether the mobile telephone number is associated with the user; and
responsive to determining the geographical region allows access to the blockchain based application and determining the mobile telephone number is associated with the user, granting access to the blockchain based application to the user.

2. The system of claim 1, wherein said user computational device comprises a communication module in communication with a cellular network, and wherein physically localizing said user computational device to said particular geographic location is performed according to said cellular network.

3. The system of claim 2, wherein said user computational device comprises a mobile telephone device.

4. The system of claim 3, wherein said mobile telephone device receives at least one SMS message and wherein information in said SMS message is transmitted to said server, to physically localize said user computational device to said particular geographic location.

5. The system of claim 1, further comprising a mobile telephone device in communication with a cellular network, wherein said mobile telephone device receives at least one SMS message and wherein information in said SMS message is transmitted to said server, to physically localize said user computational device to said particular geographic location.

6. The system of claim 1, wherein said financial instrument comprises a cryptocurrency token.

7. The system of claim 1, wherein said user computational device, said mobile telephone device, or both receive an SMS regarding distribution of an additional cryptocurrency.

8. The system of claim 1, wherein said user computational device, said mobile telephone device, or both, are in communication with said server by SMS in regard to a governance action for a cryptocurrency.

9. The system of claim 1, wherein said user computational device, said mobile telephone device, or both, are associated with a telephone number; wherein said telephone number is verified by SMS; and wherein said server compares said telephone number to a blacklist of entities, wherein if said telephone number is on said blacklist of entities, said transaction is blocked.

10. A system for managing permission to access a financial instrument on a blockchain, comprising a user computational device, a wallet address associated with said user computational device on said blockchain, a server and a computer network for communications between said user computational device and said server; wherein said financial instrument is in a first state of requiring centralized control; wherein said wallet address is on a whitelist of permitted accessing addresses and wherein said server adds said wallet address to a list of addresses having permission to access said financial instrument on said blockchain; and wherein when said financial instrument enters a second state of being decentralized, said list of addresses having permission to access said financial instrument is eliminated and any wallet address has permission to access said financial instrument.

11. The system of claim 10, wherein said server verifies an owner or beneficiary of said wallet as being permitted according to verification criteria and then adds said wallet address to a list of addresses having permission to access said financial instrument on said blockchain.

12. The system of claim 11, wherein said verification criteria comprise geographic location.

13. The system of claim 12, wherein said geographic location is determined according to a verified telephone number, wherein said verified telephone number is verified by SMS.

14. The system of claim 11, wherein said server further verifies said owner or beneficiary of said wallet according to a data collection process, wherein said data collected during said data collection process comprises one or more of: a name, an email address, a telephone number, crypto wallet information, other token type(s) stored in said wallet, any protocols the address has interacted with or transacted with.

15. The system of claim 11, wherein said blockchain comprises a plurality of different blockchains, and wherein said whitelist, said blacklist and/or said verification procedure operates across said plurality of different blockchains.

16. The system of claim 11, further comprising a smart contract for regulating access to said whitelist, said blacklist and/or said verification procedure, such that access is granted upon payment of a fee.
